(19) United States
(12) Patent Application Publication
(10) Pub. No.: US 2023/0305643 A1
(43) Pub. Date: Sep. 28, 2023

(54) JOYSTICK MODULE

(71) Applicant: LITE-ON TECHNOLOGY CORPORATION, Taipei (TW)

(72) Inventors: Chun-Tseng HUNG, Taipei (TW); Hsin-Chang CHEN, Taipei (TW); Yi-Huan CHEN, Taipei (TW); Yi-Wei CHIU, Taipei (TW); Chih-Hsien CHUANG, Taipei (TW); Chi-Feng CHEN, Taipei (TW); Ying-Jui LEE, Taipei (TW)

(21) Appl. No.: 18/124,613

(22) Filed: Mar. 22, 2023

Related U.S. Application Data
(60) Provisional application No. 63/322,651, filed on Mar. 23, 2022.
(60) Provisional application No. 63/391,807, filed on Jul. 25, 2022.

(51) Int. Cl. G06F 3/0338; G06F 3/038; G01D 5/30

(52) U.S. Cl. CPC G06F 3/0338; G06F 3/0383; G01D 5/30

(57) ABSTRACT

A joystick module includes a casing, a movable component, a circuit board, a base, a swing arm, a joystick and a sensor. The movable component is disposed inside or outside the casing. The base is disposed within the casing. The swing arm is disposed within the casing, pivotally connected to the base and connected to the movable component for driving the movable component to move. The joystick is connected to the swing arm for driving the swing arm to move. The sensor is disposed on the circuit board and opposite to the movable component, and configured to sense a plurality of received signals from the movable component. The received signals are different with the movement of the movable component.

This application claims the benefit of U.S. provisional application Ser. No. 63/322,651, filed Mar. 23, 2022, and the benefit of U.S. provisional application Ser. No. 63/391,807, filed Jul. 25, 2022, the subject matters of which are incorporated herein by reference.

### BACKGROUND OF THE INVENTION

### Field of the Invention

The invention relates in general to a joystick module.

### Description of the Related Art

When a joystick of the conventional resistive joystick module swings at an angle, a variable resistor disposed inside the resistive joystick module changes and accordingly the current flowing through the variable resistor also changes, and thus the swing angle and direction of the joystick could be obtained through such change. However, the resistive joystick module has the problem of contact wear between the resistor and a probe, and this it leads to a decrease in the service life of the joystick module and poor sensing. Therefore, proposing a joystick module that could improve the aforementioned conventional problems is one of the goals of the industry in this technical field.

### SUMMARY OF THE INVENTION

The present invention relates to a joystick module capable of resolving existing problems disclosed above.

According to one embodiment of the present invention, a joystick module is provided. The joystick module includes a casing, a movable component, a circuit board, a base, a swing arm, a joystick and a sensor. The movable component is disposed inside or outside the casing. The base is disposed within the casing. The swing arm is disposed within the casing, pivotally connected to the base and connected to the movable component for driving the movable component to move. The joystick is connected to the swing arm for driving the swing arm to move. The sensor is disposed on the circuit board and opposite to the movable component, and configured to sense a plurality of received signals from the movable component. The received signals are different with the movement of the movable component.

In the joystick module, the movable component has a reflective surface facing the sensor, and the sensor is an optical sensor.

In the joystick module, the reflective surface is a curved surface or a plane.

In the joystick module, the reflective surface is a rough surface.

In the joystick module, the swing arm is configured to drive the movable component to rotate.

In the joystick module, the movable component includes a rack and a gear. The rack has the reflective surface. The gear is engaged with the rack and configured to drive the rack to translate in a translational direction. The swing arm is connected with the gear for driving the gear to rotate.

In the joystick module, the translational direction is substantially parallel to a signal emission direction of the sensor.

In the joystick module, the translational direction is substantially perpendicular to a signal emission direction of the sensor.

In the joystick module, the swing arm is configured to drive the movable component to translate.

In the joystick module, the swing arm is directly connected to the movable component for driving the movable component to rotate.

In the joystick module, the swing arm includes a connecting end directly connected with the movable component, wherein the connecting end and the movable component are coaxially disposed.

According to another embodiment of the present invention, a joystick module is provided. The joystick module includes a casing, a reflective component, a circuit board, a base, a swing arm, a joystick, a light-emitting unit and a light-receiving unit. The reflective component is disposed inside or outside the casing. The base is disposed within the casing. The swing arm is disposed within the casing, pivotally connected to the base and connected to the reflective component for driving the reflective component to move. The joystick is connected to the swing arm for driving the swing arm to move. The light-emitting unit is disposed on the circuit board, disposed opposite to the reflective component and configured to output an emission signal to the reflective component. The light-receiving unit is disposed on the circuit board, disposed opposite to the reflective component and configured to receive a reflected signal of the transmitted signal which is reflected from the reflective component.

In the joystick module, the reflective component has a reflective surface facing the light-emitting unit and the light-receiving unit.

In the joystick module, the reflective surface is a curved surface or a plane.

In the joystick module, the swing arm is configured to drive the reflective component to rotate.

In the joystick module, the reflective component includes a rack and a gear. The rack has the reflective surface. The gear is engaged with the rack and configured for driving the rack to translate in a translational direction. The swing arm is connected with the gear for driving the gear to rotate. The swing arm is connected with the gear for driving the gear to rotate.

In the joystick module, the translational direction is substantially parallel to a signal emission direction of the sensor.

In the joystick module, the translational direction is substantially perpendicular to a signal emission direction of the sensor.

In the joystick module, the swing arm is configured to drive the movable component to translate.

According to another embodiment of the present invention, a joystick module is provided. The joystick module includes a casing, a signal generator, a circuit board, a base, a swing arm, a joystick, a signal sensor and a light-receiving unit. The signal generator is disposed outside the casing and configured to generate an emission signal. The circuit board is disposed on the base. The signal sensor is disposed on the circuit board, disposed opposite to the signal generator and configured to sense the emission signal. The swing arm is disposed within the casing and directly connected to the signal generator. The joystick connected to the swing arm for driving the swing arm to move.

In the joystick module, the swing arm includes a connecting end directly connected with the movable component, wherein the connecting end and the movable component are coaxially disposed.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 shows a schematic diagram of a joystick module according to an embodiment of the present invention;

FIG. 2 shows an internal schematic diagram of the joystick module in FIG. 2;

FIG. 3 shows a schematic diagram of an exploded view of the joystick module in FIG. 1;

FIGS. 4A to 4C show schematic views of a first movable component of the joystick module in FIG. 1 in a plurality of different positions;

FIG. 5 shows a schematic view of a relationship between a swing angle and a received signal of the joystick module in FIG. 1;

FIG. 6 shows a schematic diagram of a joystick module according to another embodiment of the present invention;

FIG. 7 shows a schematic diagram of an exploded view of the joystick module in FIG. 6;

FIGS. 8A to 8C show schematic diagrams of the first movable component of the joystick module in a plurality of different positions;

FIG. 9 shows a schematic diagram of a joystick module according to another embodiment of the present invention;

FIG. 10 shows a schematic diagram of an exploded view of the joystick module shown in FIG. 9;

FIGS. 11A to 11C show schematic diagrams of the first movable component of the joystick module in a plurality of different positions;

FIG. 12 shows a schematic diagram of a joystick module according to another embodiment of the present invention;

FIG. 13 shows a schematic diagram of an exploded view of the joystick module in FIG. 12;

FIGS. 14A to 14C show schematic diagrams of the first movable component of the joystick module in a plurality of different positions;

FIG. 15 shows a schematic diagram of a joystick module according to another embodiment of the present invention;

FIG. 16 shows a schematic diagram of a joystick module according to another embodiment of the present invention;

FIG. 17 shows an internal schematic diagram (the base and the casing not shown) of the joystick module in FIG. 16;

FIG. 18 shows a schematic diagram of an exploded view of the joystick module in FIG. 16; and

FIGS. 19A to 19C show schematic views of the first movable component of the joystick module 600 in FIG. 16 in a plurality of different positions.

### DETAILED DESCRIPTION OF THE INVENTION

Detailed descriptions of the present invention are disclosed below with accompanying drawings and exemplary embodiments. The descriptions, accompanying drawings and exemplary embodiments disclosed below are not for limiting the scope of protection of the present invention.

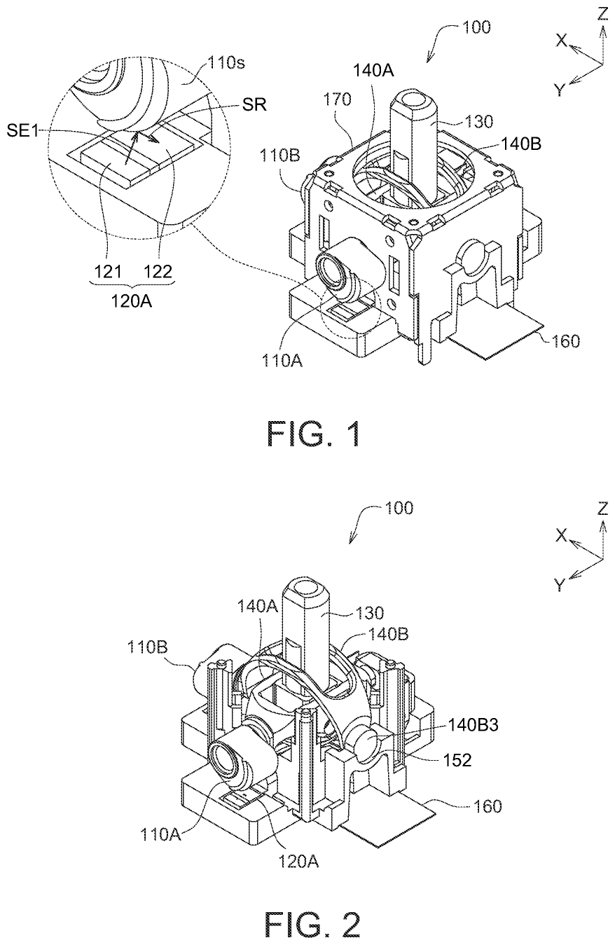

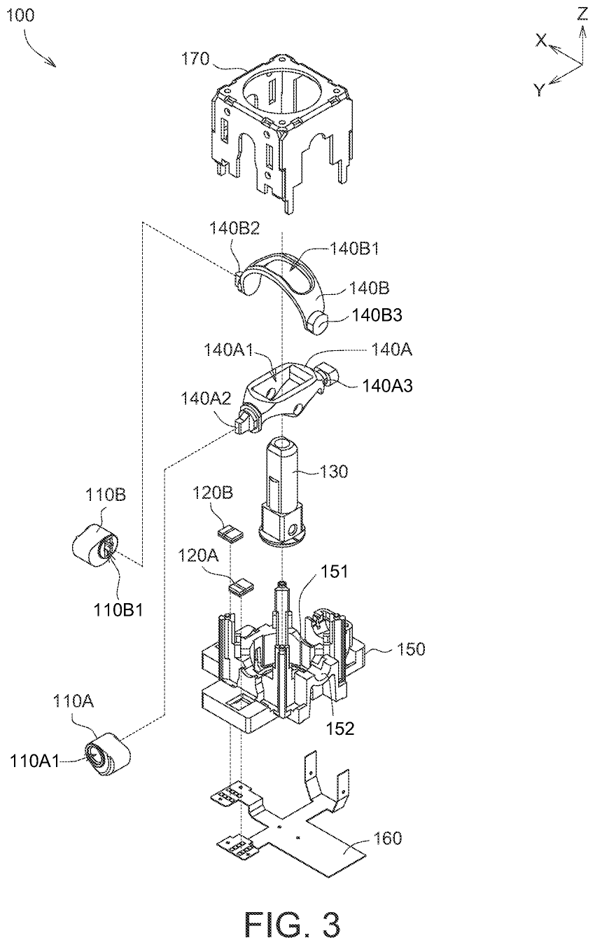

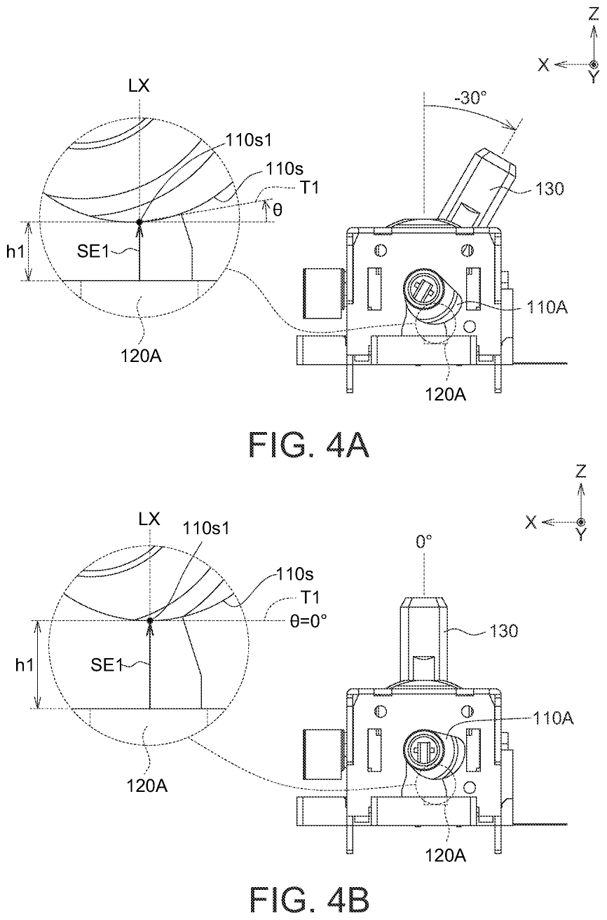

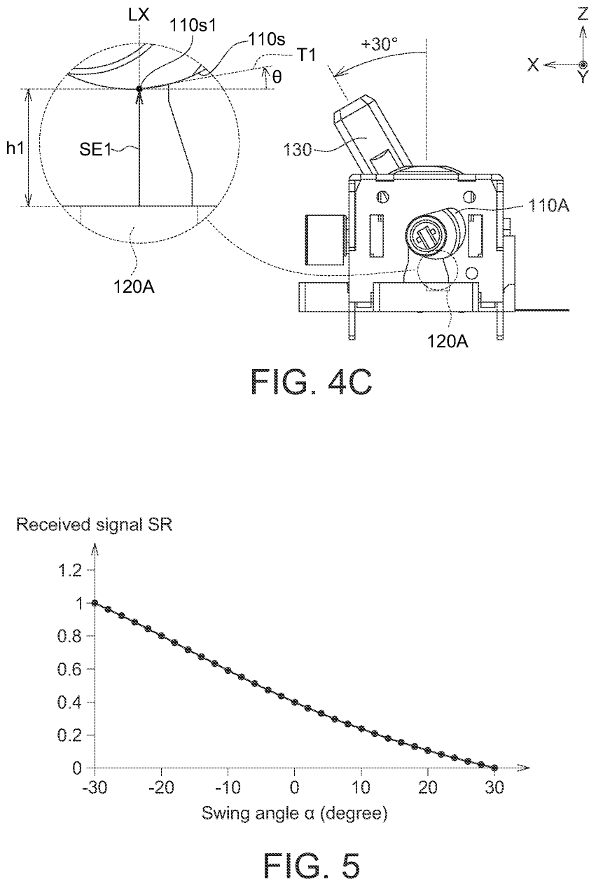

Referring to FIGS. 1 to 5, FIG. 1 shows a schematic diagram of a joystick module 100 according to an embodiment of the present invention, FIG. 2 shows an internal schematic diagram of the joystick module 100 in FIG. 2, FIG. 3 shows a schematic diagram of an exploded view of the joystick module 100 in FIG. 1, FIGS. 4A to 4C show schematic views of a first movable component 110A of the joystick module 100 in FIG. 1 in a plurality of different positions, and FIG. 5 shows a schematic view of a relationship between a swing angle α and a received signal SR of the joystick module 100 in FIG. 1.

As shown in FIG. 1, the joystick module 100 includes at least one movable component (for example, the first movable component 110A and a second movable component 110B), at least one sensor (for example, a first sensor 120A and a second sensor 120B), a joystick 130, at least one swing arm (for example, a first swing arm 140A and a second swing arm 140B), a base 150, a circuit board 160 and a casing 170.

As shown in FIG. 1, the first sensor 120A and the first movable component 110A form a first sensing group, the second sensor 120B and the second movable component 1106 form a second sensing group, and two sensing group have the same or similar technical features (structure, relative arrangement, signal sensing, etc.). The first sensor 120A and the first movable component 110A are taken as examples for illustration below.

As shown in FIG. 1, the first sensor 120A is disposed opposite to the first movable component 110A, and is configured for sensing a plurality of received signals SR from the first movable component 110A. The received signal SR varies with the motivation of the first movable component 110A. As a result, by determining the differences among these received signals SR, the position information (for example, a displacement, a displacement velocity, a displacement acceleration, an angle, an angular velocity and/or an angular acceleration) of the movable component or a component (for example, the joystick 130) connected to the movable component could be obtained.

As shown in FIG. 1, in the present embodiment, the first movable component 110A is, for example, a cam, for example, an eccentric cam. In terms of manufacturing process, the first movable component 110A could adopt an injection molding, a machining or other suitable manufacturing method. In terms of material, the first movable component 110A could be made of, for example, a plastic or a metal. In addition, the first movable component 110A is, for example, a reflective component. For example, the first movable component 110A has a reflective surface 110s facing the first sensor 120A. The first sensor 120A outputs an emission signal SE1 to the reflective surface 110s. The emission signal SE1 becomes the received signal SR after being reflected by the reflective surface 110s.

As shown in FIG. 1, the reflective surface 110s is, for example, a curved surface, but in another embodiment, the reflective surface 110s may be a plane. As long as the received signal SR could vary with the movement of the first movable component 110A, the embodiment of the present invention does not limit the geometry of the reflective surface 110s. In addition, the reflective surface 110s is, for example, a rough surface. The rough surface could scatter or diffract the emission signal SE1 to increase the amount of signal received by the first sensor 120A. In an embodiment, the reflective surface 110s has a roughness. The embodiment of the present invention does not limit the roughness range, as long as the roughness range could control the light reflection/diffraction performances of the reflective surface 110s, and coordinate with the shape design of the reflective surface 110s to make the received signal SR present a linear or approximately linear distribution. In terms of manufacturing process, the rough reflective surface 110s could be formed by an embossing method or a plastic injection molding, and the reflective surface 110s includes a plurality of concave-convex surfaces (embossed grains). In another embodiment, the reflective surface 110s could also be a smooth surface. In addition, the reflective surface 110s has a color suitable for reflecting light, such as white, but the embodiment of the present invention is not limited thereto. In an embodiment, a coating layer could be formed on the reflective surface 211s, wherein the coating layer has the aforementioned color, and the coating layer is, for example, paints, a patch, or the like. Alternatively, the material itself of the first movable component 110A1 has the aforementioned color.

As shown in Table 1 below, it lists one of a number of the profile designs of the reflective surface 110s. The swing angle α is the angle at which the joystick 130 swings around the Y-axis, and swing angle α is defined as 0 degrees when the joystick 130 is parallel to the Z-axis (as shown in FIG. 4B). The rotation around the −Y-axis is defined as a negative swing angle (as shown in FIG. 4A), and the rotation around the +Y-axis is defined as a positive swing angle (as shown in FIG. 4C). There is a corresponding relationship between a plurality of the swing angles α in Table 1 and a plurality of points in FIG. 5. As shown in FIGS. 4A to 4C, the reflective surface angle θ in Table 1 is a tangent line (or tangential plane) direction T1 between a tangent line (or a tangential plane) direction T1 and a horizontal plane (for example, parallel to the X-axis). A reflective surface height h1 in Table 1 is the distance between the reflective portion 110s1 and the first sensor 120A. The “reflective portion” herein refers to the portion where the emission signal is incident on the reflective surface, and it could be a point, line or surface of the reflective surface.

TABLE 1

| | reflective surface | reflective surface |
|---|---|---|
| swing angle α | angle θ | height h1 |
| (degree) | (degree) | (millimeter) |
| −30 | 3.07 | 0.96 |
| (FIG. 4A) | | |
| −28 | 2.68 | 0.99 |
| −26 | 2.32 | 1.02 |
| −24 | 1.98 | 1.05 |
| −22 | 1.67 | 1.08 |
| −20 | 1.38 | 1.12 |
| −18 | 1.12 | 1.15 |
| −16 | 0.89 | 1.18 |
| −14 | 0.68 | 1.22 |
| −12 | 0.50 | 1.25 |
| −10 | 0.35 | 1.28 |
| −8 | 0.22 | 1.32 |
| −6 | 0.13 | 1.35 |
| −4 | 0.06 | 1.39 |
| −2 | 0.01 | 1.42 |
| 0 | 0.00 | 1.46 |
| (FIG. 4B) | | |
| 2 | 0.01 | 1.49 |
| 4 | 0.06 | 1.53 |
| 6 | 0.13 | 1.56 |
| 8 | 0.22 | 1.60 |
| 10 | 0.35 | 1.63 |
| 12 | 0.50 | 1.67 |
| 14 | 0.68 | 1.70 |
| 16 | 0.89 | 1.73 |
| 18 | 1.12 | 1.77 |
| 20 | 1.38 | 1.80 |
| 22 | 1.67 | 1.83 |
| 24 | 1.98 | 1.87 |
| 26 | 2.32 | 1.90 |
| 28 | 2.68 | 1.93 |
| 30 | 3.07 | 1.96 |
| (FIG. 4C) | | |

Table 1 is merely an example of a plurality of profile designs of the first movable component 110A, and it is not intended to limit the embodiment of the present invention. In another embodiment, depending on actual needs, the values of the reflective surface angle θ and/or the reflective surface height h1 in Table 1 could be adjusted within +/−30%.

It could be seen from FIGS. 4A to 4C that the reflective surface height h1 changes with different time points during the movement of the first movable component 110A, so that the transmission path lengths of the emission signal SE1 and the received signal SR also vary with the reflective surface height h1 (for example, the reflective surface height h1 is proportional to the length of the transmission path), and it causes the received signal SR from the first movable component 110A to be different accordingly (for example, the reflective surface height h1 is inversely proportional to the received signal SR).

As shown in FIG. 5, due to the profile design of the first movable component 110A, during the swing process of the swing angle α ranging between −30° and +30°, the first sensor 120A receives a plurality of different receive signals SR. The received signals SR present substantially linear or approximately linear distribution. The linear distribution could conform to the operating habit of the operator (with the change of the swing angle, the operator expects the to-be-operated object or image to change or move in close to the same proportion). In another embodiment, a plurality of the received signals SR received by the first sensor 120A could also be non-linearly distributed.

In the present embodiment, the sensor is, for example, an optical sensor, the aforementioned emission signal SE1 is, for example, an emission light signal, and the received signal SR is, for example, a received light signal. The light color of the sensor (for example, the light wavelength of the light-emitting unit) could be adjusted according to actual conditions. Furthermore, the light color of the sensor will affect the signal intensity reflected by the reflective surface back to the light-receiving unit. If a light source with a color wavelength close to that of the reflective surface is selected, the light intensity received by the light-receiving unit could be enhanced, and the power supply (wattage) required by the sensor will also be reduced. In addition, the lower the ratio of the intensity of ambient light wavelengths in the emission light emitted by the light-emitting unit, the lower the impact of an ambient light on the signal (for example, noise), and the better the signal stability that could be improved. For example, the first sensor 120A includes a light-emitting unit 121 and a light-receiving unit 122. The light-emitting unit 121 is, for example, a light emitting diode, a laser diode (for example, a vertical-cavity surface-emitting laser (VCSE)) and the like. The light-emitting unit 121 could output out the emission light (the emission signal SE1) toward the reflection surface 110s, and the emission light reflected from the reflection surface 110s becomes the reflected light (the received signal SR). By the optical non-contact detection method, the wear of the components could be reduced and the service life of the device could be improved.

As shown in FIGS. 4A to 4C, an optical axis LX of the emission signal SE1 emitted by the light-emitting unit 121 of the first sensor 120A is substantially coincident with (or overlap) the reflective portion 110s1 of the reflection surface 110s. The intensity of the emission signal SE1 along the optical axis LX is the strongest and the most stable.

In the present embodiment, the first swing arm 140A, the first movable component 110A and the first sensor 120A could form a first swing sensing mechanism, and it could provide a degree of freedom to swing around an axial direction, and accordingly detect the swing angle of the joystick, while the second swing arm 140B, the second movable component 110B and the second sensor 120B could form a second swing sensing mechanism, and it could provide a degree of freedom to swing in another axial direction, and accordingly detect the corresponding swing angle of the joystick.

As shown in FIGS. 2 to 3, the swing arm is connected to the movable component for driving the movable component to rotate. For example, the joystick 130 could be connected to the first swing arm 140A and the second swing arm 1406 for driving the first swing arm 140A and the second swing arm 140B to swing. The first swing arm 140A has a first slot 140A1 extending in the Y-axis, and the second swing arm 140B has a second slot 140B1 extending in the X-axis. The joystick 130 could pass through the first slot 140A1 of the first swing arm 140A and the second slot 140B1 of the second swing arm 140B. As the joystick 130 moves in the Y-axis, the second swing arm 140B could be driven to swing around the X-axis. As the joystick 130 moves in the X-axis, the first swing arm 140A could be driven to swing around the Y-axis.

As shown in FIGS. 2 to 3, the first swing arm 140A is connected to the aforementioned first movable component 110A. For example, the first swing arm 140A includes a first connecting end 140A2 fixed to (for example, tightly fitted) to a hole 110A1 of the first movable component 110A. As a result, as the first swing arm 140A swings around the Y-axis, the first movable component 110A swings around the Y-axis synchronously. The second swing arm 140B is connected to the aforementioned second movable component 1106. For example, the second swing arm 140B includes a second connecting end 140B2 fixed to (for example, tightly fitted) to the hole 110B1 of the second movable component 1106. As a result, as the second swing arm 140B swings around the X-axis, the second movable component 1106 swings around the X-axis synchronously.

As shown in FIGS. 2 to 3, the first swing arm 140A and the second swing arm 140B could be pivotally connected to the base 150. For example, the first swing arm 140A further includes a first pivot portion 140A3, the second swing arm 140B further includes a second pivot portion 14063, and the base 150 includes a third pivot portion 151 and a fourth pivot portion 152. The first swing arm 140A is pivotally connected to the third pivot portion 151 of the base 150 by the first pivot portion 140A3, and the second swing arm 140B is pivotally connected to the four pivot portions 152 of the base 150 by the second pivot portion 140B3. In the present embodiment, the third pivotal portion 151 and the fourth pivotal portion 152 are, for example, recesses, and the first pivotal portion 140A3 and the second pivotal portion 140B3 are, for example, pivot shafts. In another embodiment, the third pivotal portion 151 and the fourth pivotal portion 152 are, for example, pivot shafts and the first pivotal portion 140A3 and the second pivotal portion 140B3 are, for example, recesses.

As shown in FIGS. 2 to 3, the circuit board 160 could be disposed on a lower surface of the base 150. The aforementioned first sensor 120A and second sensor 120B could be disposed on and electrically connected to the circuit board 160. The received signal SR received by the sensors (for example, the first sensor 120A and the second sensor 120B) could be transmitted to a controller (not shown) through the circuit board 160, and the controller could analyze the received signal SR to obtain the swing angle α of the joystick 130.

As shown in FIGS. 2 to 3, the casing 170 could cover the first swing arm 140A, the second swing arm 140B and a portion of the base 150 to prevent an external object from interfering with the movement of the swing arm.

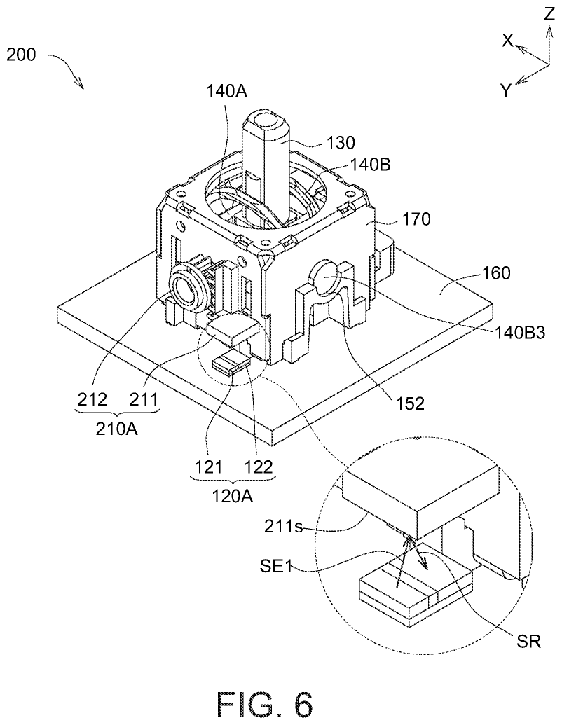

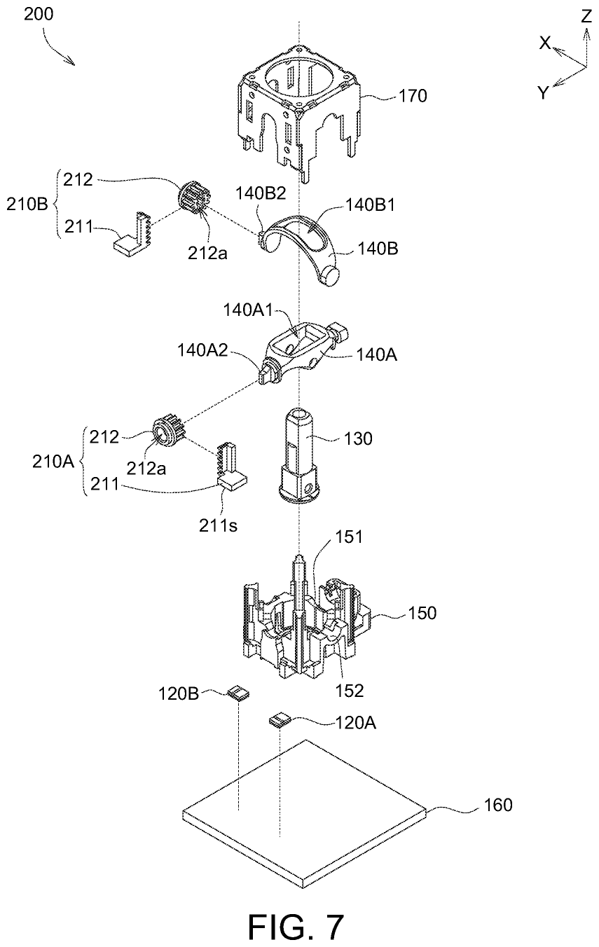

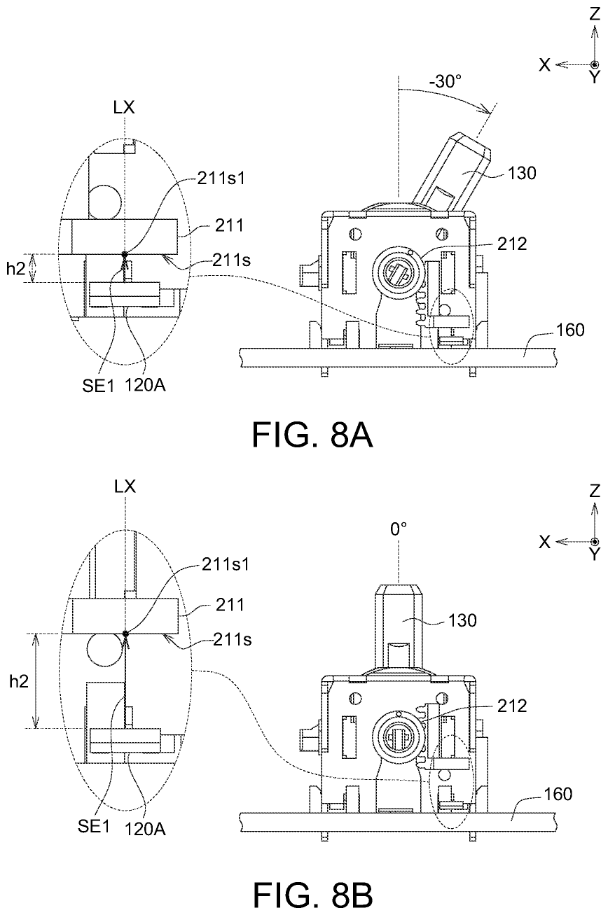

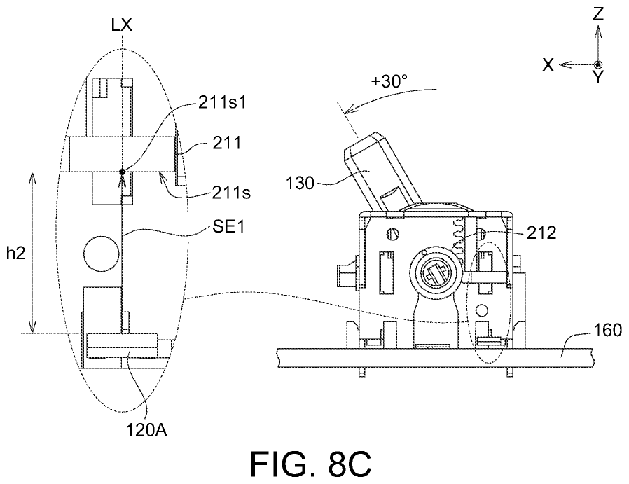

Refer to FIGS. 6 to 8C, FIG. 6 shows a schematic diagram of a joystick module 200 according to another embodiment of the present invention, FIG. 7 shows a schematic diagram of an exploded view of the joystick module 200 in FIG. 6, and FIGS. 8A to 8C show schematic diagrams of the first movable component 210A of the joystick module 200 in a plurality of different positions.

As shown in FIGS. 6 to 7, the joystick module 200 includes at least one movable component (for example, a first movable component 210A and a second movable component 210B), at least one sensor (for example, the first sensor 120A and the second Two sensors 120B), the joystick 130, at least one swing arm (for example, first swing arm 140A and second swing arm 140B), the base 150, the circuit board 160 and casing 170.

The joystick module 200 of the present embodiment has the features same as or similar to that of the aforementioned joystick module 100. At least one difference is that the structure of the movable components of the joystick module 200 and the structure of the movable components of the joystick module 100 are different.

In the present embodiment, the first sensor 120A and the first movable component 210A form a first sensing group, the second sensor 120B and the second movable component 210B form a second sensing group, and two sensing group have the same or similar technical features (structure, relative arrangement, signal sensing, etc.). The first sensor 120A and the first movable component 210A are taken as examples for illustration below.

As shown in FIGS. 6 to 7, the first sensor 120A is disposed opposite to the first movable component 210A, and is configured for sensing a plurality of received signals SR from the first movable component 210A. The received signal SR varies with the motivation of the first movable component 210A. As a result, by determining the differences among these received signals SR, the position information of the movable component or a component (for example, the joystick 130) connected to the movable component could be obtained.

As shown in FIGS. 6 to 7, in the present embodiment, the first movable component 210A is, for example, a set of a rack and a gear. For example, the first movable component 210A includes a rack 211 and a gear 212. In terms of manufacturing process, the rack 211 and the gear 212 could be firmed by using an injection molding, a machining or other suitable manufacturing method. In terms of material, the rack 211 and the gear 212 could be formed of, for example, plastic or metal. The first movable component 210A is, for example, a reflective component. For example, the rack 211 of the first movable component 210A has a reflective surface 211s facing the first sensor 120A. The first sensor 120A sends an emission signal SE1 to the reflective surface 211s. The gear 212 is engaged with (or meshed to) the rack 211 and configured to drive the rack 211 to translate in a translational direction (for example, the Z-axis). As a result, as the rack 211 moves, its reflective surface 211s also moves synchronously, so that the receiving signal SR from the first movable component 210A could change accordingly.

As shown in FIGS. 6 to 7, the reflective surface 211s is, for example, a plane, such as a horizontal plane, which is substantially parallel to the XY plane. In another embodiment, the reflective surface 211s is, for example, an inclined plane. For example, a non-zero angle is included between the reflective surface 211s and the XY plane. In other embodiments, the reflective surface 211s could be a curved surface. However, as long as the received signal SR could vary with the movement of the first movable component 210A, the embodiment of the present invention does not limit the geometry of the reflective surface 211s. In addition, the reflective surface 211s is, for example, a rough surface. The rough surface could diffract the emission signal SE1 and increase the amount of signal received by the first sensor 120A. In an embodiment, the reflective surface 211s has a roughness that is the same as or closes to that of the aforementioned reflective surface 110s. The manufacturing process and/or structure of the reflective surface 211s are similar to that of the above-mentioned reflective surface 110s, and the similarities will not be repeated here.

Although not shown, the rack 211 of the first movable component 210A includes a first sliding portion, and the casing 170 includes a second sliding portion, and the first sliding portion of the rack 211 of the first movable component 210A is relatively slidably connected to the second sliding portion of the casing 170. In an embodiment, the first sliding portion is one of a sliding slot (for example, extending in the Z-axis) and a protrusion, and the second sliding portion is the other of the sliding slot and the protrusion. In another embodiment, the second sliding portion could be disposed on the base 150, and the first sliding portion of the rack 211 is connected to the second sliding portion of the base 150 after passing through the casing 170.

Similarly, although not shown, the rack 211 of the second movable component 210B includes a first sliding portion, and the base 150 includes a second sliding portion, and the first sliding portion of the rack 211 of the second movable component 2106 is relatively slidably connected to the second sliding portion of the base 150. In an embodiment, the first sliding portion is one of the sliding slot (for example, extending in the Z-axis) and the protrusion, and the second sliding portion is the other of the sliding slot and the protrusion.

As shown in FIGS. 6 to 7, the translational direction (for example, parallel to the Z-axis) of the rack 211 of the first movable component 210A is substantially parallel to a signal emission direction (for example, parallel to the Z-axis) of the first sensor 120A. As a result, as the rack 211 translates in the signal emission direction, the distance between the reflective surface 211s and the first sensor 120A changes, and accordingly the received signal SR reflected from the reflective surface 211s changes.

For example, as shown in FIGS. 8A to 8C, there is a distance h2 between the reflective portion 211s1 of the reflection surface 211s and the first sensor 120A, wherein the distance h2 changes (for example, a height position in the Z-axis) with the movement of the first movable component 210A, and accordingly the received signal SR reflected from the reflective portion 211s1 also changes. In an embodiment, the received signal SR is inversely proportional to the distance h2. In addition, the optical axis LX of the emission signal SE1 emitted by the first sensor 120A could coincide with (or overlap) the reflective surface 211s.

Due to the design of the set of the rack and gear, the rotation angle of the gear 212 and the translational stroke of the rack 211 are in linear relationship. In addition, the gear 212 and the joystick 130 also rotate synchronously. As a result, the swing angle α of the joystick 130 and the distance h2 are in linear relationship, so that the swing angle α and the received signal SR are in linear relationship.

In the present embodiment, the first swing arm 140A, the first movable component 210A and the first sensor 120A could form a first swing sensing mechanism, and it could provide a degree of freedom to swing in an axial direction, and accordingly detect the swing angle of the joystick, while the second swing arm 140B, the second movable component 210B and the second sensor 120B could form a second swing sensing mechanism, and it could provide a degree of freedom to swing in another axial direction, and accordingly detect the corresponding swing angle of the joystick.

As shown in FIGS. 6 to 7, the swing arm is connected to the movable component to drive the movable component to translate. For example, the first swing arm 140A is connected to the first movable component 210A, for example, the gear 212 is connected to the first movable component 210A. For example, the first swing arm 140A includes the first connecting end 140A2 fixed to a hole 212a of the gear 212 of the first movable component 210A. As the first swing arm 140A swings around the Y-axis, the gear 212 of the first movable component 210A synchronously rotates around the Y-axis, and synchronously drives the rack 211 of the first movable component 210A to translate in the Z-axis. The second swing arm 140B is connected to the aforementioned second movable component 210B, for example, the gear 212 connected to the second movable component 210B. For example, the second swing arm 140B includes the second connecting end 140B2 fixed to a hole 212a of the gear 212 of the second movable component 210B. As the second swing arm 140B swings around the X-axis, the gear 212 of the second movable component 210B synchronously rotates around the X-axis, and synchronously drives the rack 211 of the second movable component 210B to translate in the Z-axis.

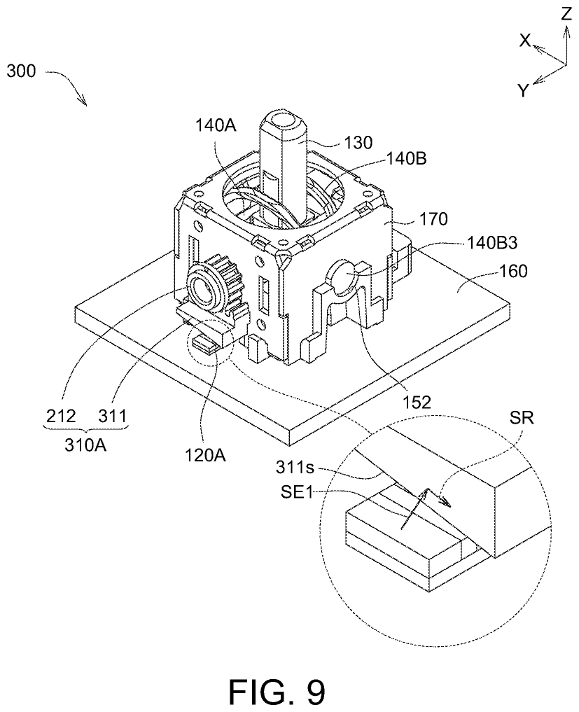

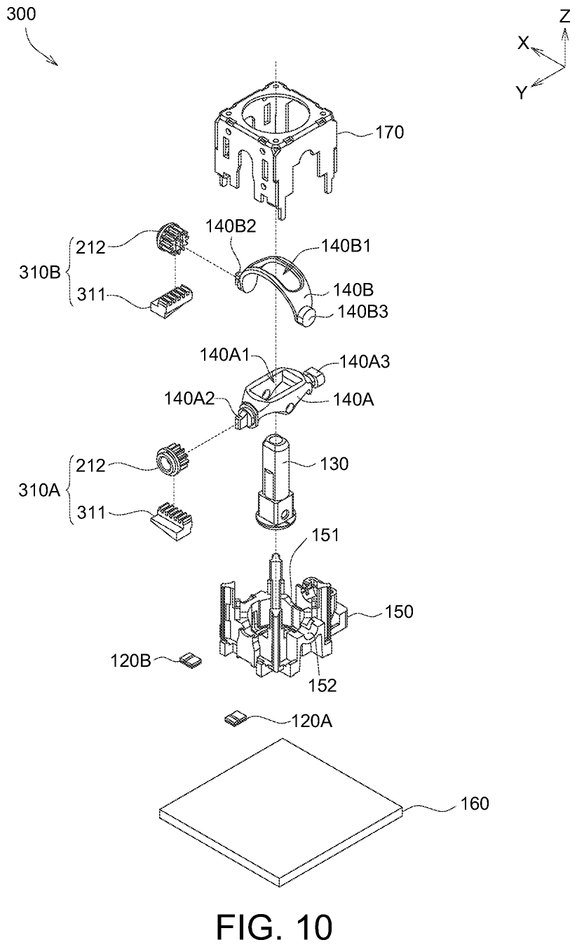

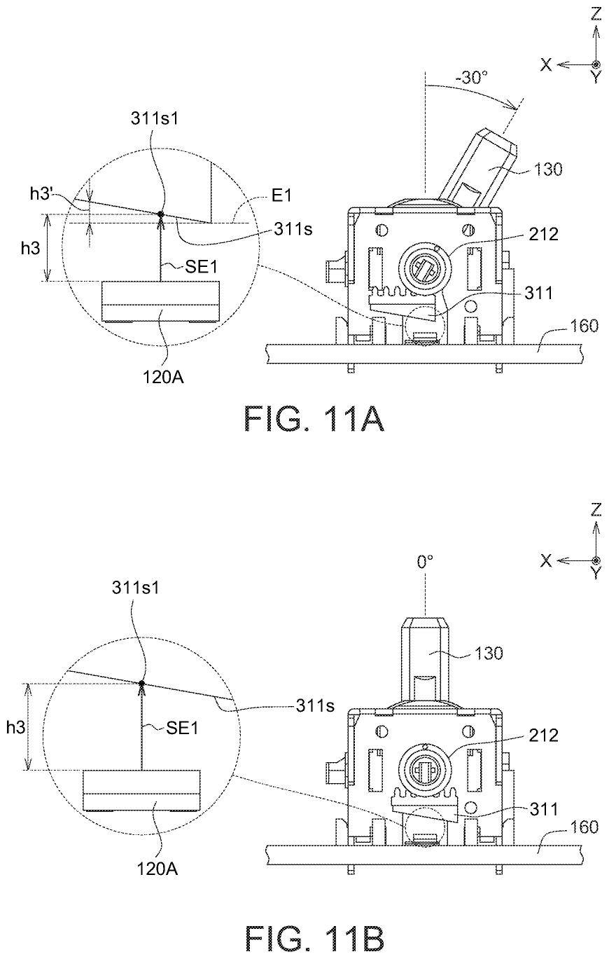

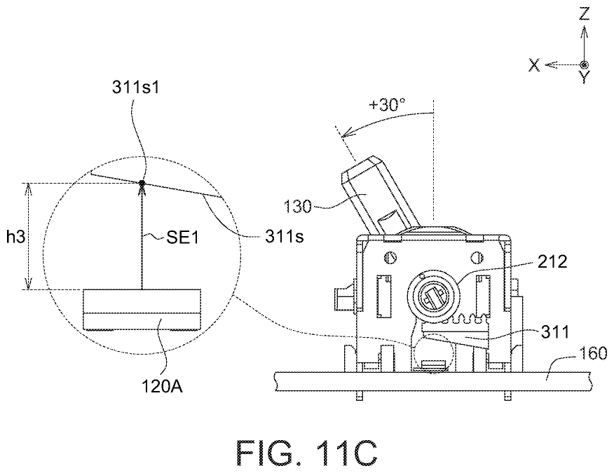

Referring to FIGS. 9 to 11C, FIG. 9 shows a schematic diagram of a joystick module 300 according to another embodiment of the present invention, FIG. 10 shows a schematic diagram of an exploded view of the joystick module 300 shown in FIG. 9, and FIGS. 11A to 11C show schematic diagrams of the first movable component 310A of the joystick module 300 in a plurality of different positions.

As shown in FIGS. 9 to 10, the joystick module 300 includes at least one movable component (for example, a first movable component 310A and a second movable component 310B), at least one sensor (for example, the first sensor 120A and the second Two sensors 120B), the joystick 130, at least one swing arm (for example, first swing arm 140A and second swing arm 140B), the base 150, the circuit board 160 and casing 170.

The joystick module 300 of the present embodiment has technical features the same as or similar to that of the aforementioned joystick module 200, at least one difference is that the movable components of the joystick module 300 (the first movable component 310A and/or the second movable 310B) is different from the structure of the movable components (the first movable component 210A and/or the second movable component 2106) of the joystick module 200.

In the present embodiment, the first sensor 120A and the first movable component 310A form a first sensing group, the second sensor 120B and the second movable component 310B form a second sensing group, and two sensing group have the same or similar technical features (structure, relative arrangement, signal sensing, etc.). The first sensor 120A and the first movable component 310A are taken as examples for illustration below.

As shown in FIGS. 9 to 10, the first sensor 120A is disposed opposite to the first movable component 310A and configured for sensing the received signal SR from the first movable component 310A. A plurality of the received signals SR is different with the movement of the first movable component 310A. As a result, by determining the differences among these received signals SR, the position information of the movable component or a component (for example, the joystick 130) connected to the movable component could be obtained.

As shown in FIGS. 9 to 10, in the present embodiment, the first movable component 310A is, for example, a set of a rack and a gear. For example, the first movable component 310A includes a rack 311 and the gear 212. In terms of manufacturing process, the rack 311 and the gear 212 could be firmed by using an injection molding, a machining or other suitable manufacturing method. In terms of material, the rack 311 and the gear 212 could be formed of, for example, plastic or metal. The first movable component 310A is, for example, a reflective component. For example, the rack 311 of the first movable component 310A has a reflective surface 311s facing the first sensor 120A. The first sensor 120A outputs an emission signal SE1 to the reflective surface 311s. The gear 212 is engaged with (or meshed to) the rack 311 and configured to drive the rack 311 to translate in a translational direction (for example, the X-axis). As a result, as the rack 311 moves, its reflective surface 311s also moves synchronously, so that the receiving signal SR from the first movable component 310A could change accordingly.

As shown in FIGS. 9 to 10, the reflective surface 311s of the first movable component 310A is, for example, a plane, such as an inclined plane. A non-zero angle is included between the reflective surface 311s and the XY plane. There is a distance h3′ between the reflective surface 311s and a reference E1 of the rack 311 (for example, parallel to the XY plane), and the distance h3′ gradually increases in the +X-axis. The reference E1 may be a portion of the rack 311, for example, a bottom surface of the rack 311. In another embodiment, the reflective surface 311s could be a curved surface. However, as long as the received signal SR could vary with the movement of the first movable component 310A, the embodiment of the present invention does not limit the geometry of the reflective surface 311s. In addition, the reflective surface 311s is, for example, a rough surface. The rough surface could diffract the emission signal SE1 and increase the amount of signal received by the first sensor 120A. In an embodiment, the reflective surface 311s has a roughness that is the same as or closes to that of the aforementioned reflective surface 110s. The manufacturing process and/or structure of the reflective surface 311s are similar to that of the aforementioned reflective surface 110s, and the similarities will not be repeated here.

Although not shown, the rack 311 of the first movable component 310A includes a first sliding portion, and the base 150 includes a second sliding portion, and the first sliding portion of the rack 311 of the first movable component 310A is relatively slidably connected to the second sliding portion of the base 150. In an embodiment, the first sliding portion is one of a sliding slot (for example, extending in the X-axis) and a protrusion, and the second sliding portion is the other of the sliding slot and the protrusion.

Similarly, although not shown, the rack 311 of the second movable component 310B includes the first sliding portion, and the base 150 includes a second sliding portion, and the first sliding portion of the rack 311 of the second movable component 3106 is relatively slidably connected to the second sliding portion of the base 150. In an embodiment, the first sliding portion is one of the sliding slot (for example, extending in the Y-axis) and the protrusion, and the second sliding portion is the other of the sliding slot and the protrusion.

As shown in FIGS. 9 to 10, the translational direction (for example, parallel to the X-axis) of the rack 311 of the first movable component 310A is substantially perpendicular to the signal emission direction (for example, parallel to the Z-axis) of the first sensor 120A. As a result, as the rack 311 translates in the signal emission direction, the distance between the reflective surface 311s and the first sensor 120A changes, and accordingly the received signal SR reflected from the reflective surface 311s changes.

For example, as shown in FIGS. 11A to 11C, there is a distance h3 between the reflective portion 311s1 of the reflection surface 311s of the first movable component 310A and the first sensor 120A, wherein the distance h3 changes (for example, a height position in the X-axis) with the movement of the first movable component 310A, and accordingly the received signal SR reflected from the reflective portion 311s1 also changes. In an embodiment, the received signal SR is inversely proportional to the distance h3. In addition, the optical axis LX of the emission signal SE1 emitted by the first sensor 120A could coincide with (or overlap) the reflective surface 311s.

Due to the design of the set of the rack and gear, the rotation angle of the gear 212 and the translational stroke of the rack 311 are in linear relationship. In addition, the gear 212 and the joystick 130 also rotate synchronously. As a result, the swing angle α of the joystick 130 and the distance h3 are in linear relationship, so that the swing angle α and the received signal SR are in linear relationship.

In the present embodiment, the first swing arm 140A, the first movable component 310A and the first sensor 120A could form a first swing sensing mechanism, and it could provide a degree of freedom to swing around an axial direction, and accordingly detect the swing angle of the joystick, while the second swing arm 140B, the second movable component 310B and the second sensor 120B could form a second swing sensing mechanism, and it could provide a degree of freedom to swing around another axial direction, and accordingly detect the corresponding swing angle of the joystick.

As shown in FIGS. 9 to 10, the swing arm is connected to the movable component to drive the movable component to translate. For example, the first swing arm 140A is connected to the first movable component 310A, for example, the gear 212 is connected to the first movable component 310A. For example, the first swing arm 140A includes the first connecting end 140A2 fixed to (for example, tightly fitted) the hole 212a of the gear 212 of the first movable component 310A. As the first swing arm 140A swings around the Y-axis, the gear 212 of the first movable component 310A synchronously rotates around the Y-axis, and synchronously drives the rack 311 of the first movable component 310A to translate in the Z-axis. The second swing arm 140B is connected to the aforementioned second movable component 310B, for example, the gear 212 connected to the second movable component 310B. For example, the second swing arm 140B includes the second connecting end 140B2 fixed to (for example, tightly fitted) the hole 212a of the gear 212 of the second movable component 310B. As the second swing arm 140B swings around the X-axis, the gear 212 of the second movable component 310B synchronously rotates around the X-axis, and synchronously drives the rack 211 of the second movable component 310B to translate in the Z-axis (not visible from the perspective of FIG. 9).

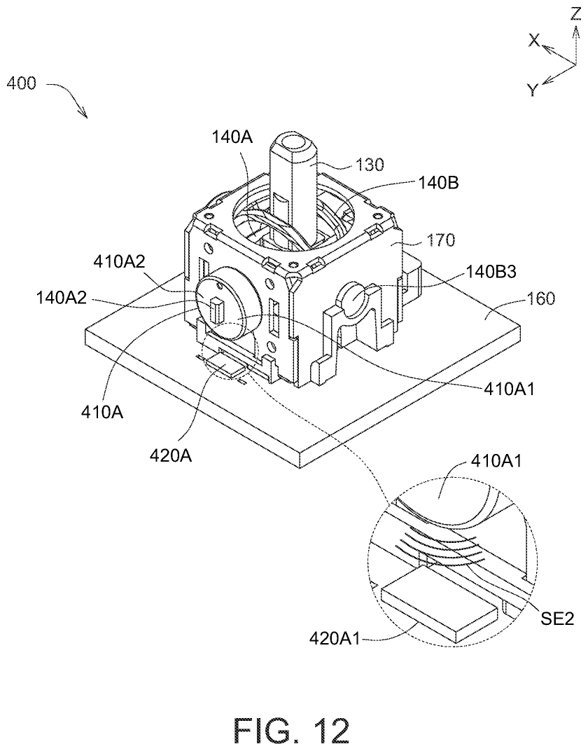

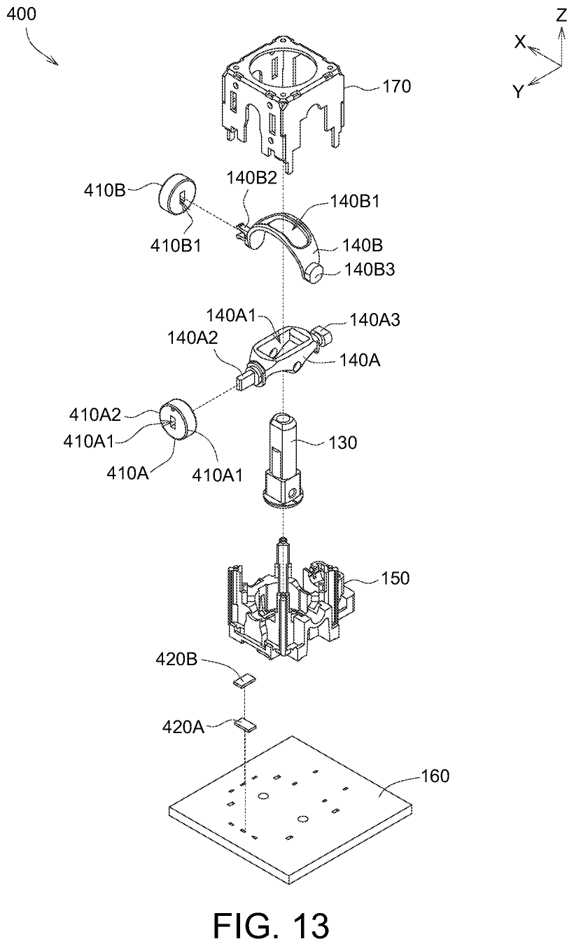

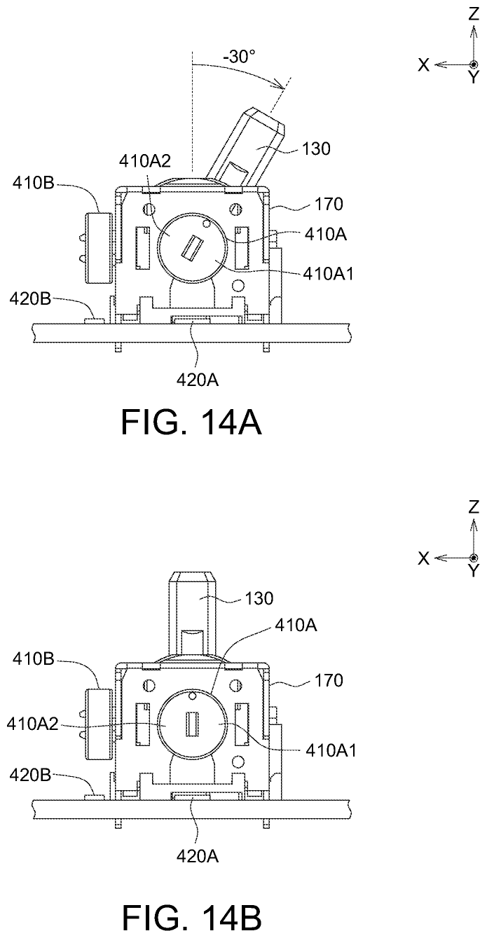

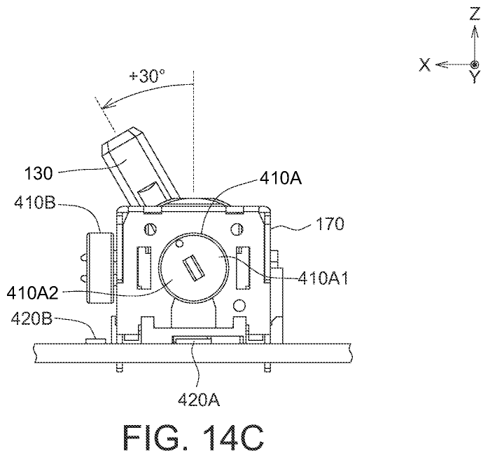

Refer to FIGS. 12 to 14C, FIG. 12 shows a schematic diagram of a joystick module 400 according to another embodiment of the present invention, FIG. 13 shows a schematic diagram of an exploded view of the joystick module 400 in FIG. 12, and FIGS. 14A to 14C show schematic diagrams of the first movable component 410A of the joystick module 400 in a plurality of different positions.

As shown in FIGS. 12 to 13, the joystick module 400 includes at least one movable component (for example, a first signal generator 410A and a second signal generator 410B), at least one sensor (for example, a first signal sensor 420A and the second signal sensor 420B), the joystick 130, at least one swing arm (for example, the first swing arm 140A and the second swing arm 140B), the base 150, the circuit board 160 and the casing 170.

In the present embodiment, the first signal sensor 420A and the first signal generator 410A form a first sensing group, the second signal sensor 420B and the second signal generator 4106 form a second sensing group, and two sensing group have the same or similar technical features (structure, relative arrangement, signal sensing, etc.). The first signal sensor 420A and the first signal generator 410A are taken as examples for illustration below.

As shown in FIGS. 12 to 13, the first signal generator 410A could generate an emission signal SE2. The first signal sensor 420A is disposed opposite to the first signal generator 410A and configured for sensing the emission signal SE2 from the first signal generator 410A. The first swing arm 140A is directly connected to the first signal generator 410A. The first swing arm 140A could drive the first signal generator 410A to move, so that a plurality of the emission signals SE2 sensed by the first signal sensor 420A are different according to the movement of the first signal generator 410A. As a result, by determining the differences among these emission signals SE1, the position information of the signal generator or a component (for example, the joystick 130) connected to the signal generator could be obtained.

As shown in FIGS. 12 to 13, in the present embodiment, the first signal generator 410A is, for example, a component capable of generating a magnetic field, such as a magnet. The first signal generator 410A has a first end 410A1 and a second end 410A2 opposite to the first end 410A1. The first end 410A1 is, for example, one of the N pole and the S pole, and the second end 410A2 is, for example, the other of the N pole and the S pole. The first signal sensor 420A is, for example, a Hall sensor which could sense change of the magnetic field. For example, as the first signal generator 410A moves (for example, rotates), the emission signal SE2 (for example, magnetic field) generated by the first signal generator 410A changes accordingly, and the first signal sensor 420A could detect such signal change. As a result, by determining the differences among these emission signals SE2, the first signal sensor 420A could obtain the position information of the signal generator or a component (for example, the joystick 130) connected to the signal generator.

In the present embodiment, by the magnetic induction non-contact detection method, the wear of the components could be reduced and the service life of the device could be improved.

As shown in FIGS. 14A to 14C, as the rotation of the first signal generator 410A, the position of the first end 410A1 and the position of the second end 410A2 change, and accordingly the generated magnetic field also changes, and the change of the magnetic field could be detected by the first signal sensor 420A. A controller (not shown) could analyze the received signal by the first signal sensor 420A to obtain the swing angle α of the joystick 130.

In the present embodiment, the shape of the first signal generator 410A and the shape of the second signal sensor 420B are the same, for example, circular shape, but the present embodiment of the present invention is not limited thereto. In another embodiment, the shape of the first signal generator 410A and the shape of the second signal sensor 420B could be different, for example, circle, polygon, ellipse and so on.

In the present embodiment, the first swing arm 140A, the first movable component 410A and the first sensor 120A could form a first swing sensing mechanism, and it could provide a degree of freedom to swing around an axial direction, and accordingly detect the swing angle of the joystick, while the second swing arm 140B, the second movable component 410B and the second sensor 120B could form a second swing sensing mechanism, and it could provide a degree of freedom to swing around another axial direction, and accordingly detect the corresponding swing angle of the joystick.

As shown in FIGS. 12 to 13, the swing arm is connected to the movable component to drive the movable component to rotate. For example, the first swing arm 140A is connected to the first signal generator 410A. For example, the first swing arm 140A includes a first connecting end 140A2 fixed to (for example, tightly fitted) to a hole 410A1 of the first movable component 410A. The first connection end 140A2 of the first swing arm 140A could be directly connected to the hole 410A1 of the first signal generator 410A. The first connection end 140A2 and the first signal generator 410A could be coaxially disposed. As the first swing arm 140A swings around the Y-axis, the first signal generator 410A rotates around the Y-axis synchronously. Similarly, the second swing arm 1406 is connected to the second signal generator 4106. For example, the second swing arm 140B includes a second connecting end 140B2 fixed to (for example, tightly fitted) to a hole 410B1 of the second movable component 410B. The second connecting end 140B2 of the second swing arm 140B could be directly connected to the second signal generator 410B. The second connection terminal 140B2 and the second signal generator 410B could be coaxially disposed. As the second swing arm 140B swings around the X-axis, the second signal generator 4106 rotates around the Y-axis synchronously.

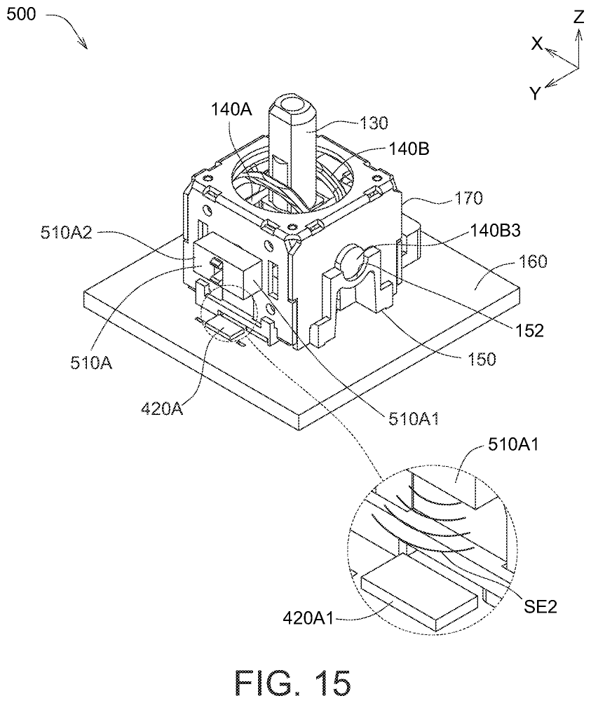

Referring to FIG. 15, FIG. 15 shows a schematic diagram of a joystick module 500 according to another embodiment of the present invention. The joystick module 500 includes at least one movable component (for example, a first signal generator 510A and a second signal generator 510B), at least one sensor (for example, the first signal sensor 420A and the second signal sensor 420B), the joystick 130, at least one swing arm (for example, the first swing arm 140A and second swing arm 140B), the base 150, the circuit board 160 and the casing 170.

The joystick module 500 of the embodiment of the present invention has the technical features the same as or similar to that of the joystick module 400, the difference is that the first signal generator 510A and the second signal generator 5106 of the joystick module 500 are different from the first signal generator 410A and the second signal generator 410B of the joystick module 500 in structure.

In the present embodiment, the shape of the first signal generator 510A and the shape of the second signal sensor 520B are, for example, rectangular shapes. In another embodiment, the shape of the first signal generator 510A and the shape of the second signal sensor 520B could be different, for example, circular shapes, polygonal shapes, ellipse s and so on.

In the present embodiment, the first signal generator 510A is, for example, a component capable of generating a magnetic field, such as a magnet. The first signal generator 510A has a first end 510A1 and a second end 510A2 opposite to the first end 510A1. The first end 510A1 is, for example, one of the N pole and the S pole, and the second end 510A2 is, for example, the other of the N pole and the S pole. As the first signal generator 510A moves (for example, rotates), the emission signal SE2 generated by the first signal generator 510A changes accordingly. As a result, by determining the differences among these emission signals SE2, the first signal sensor 420A could obtain the position information of the signal generator or a component (for example, the joystick 130) connected to the signal generator. The second signal generator 5106 has similar features, and the similarities will not be repeated here.

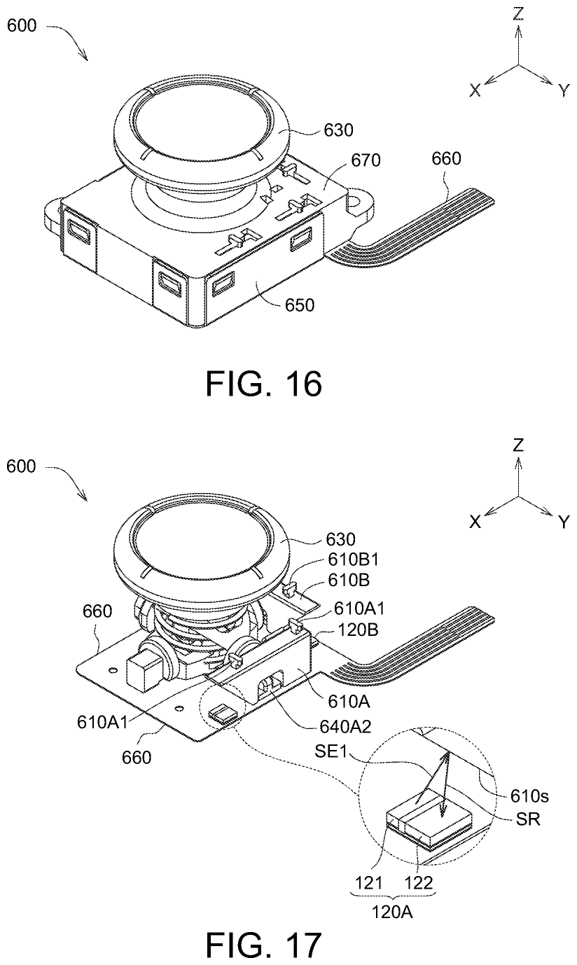

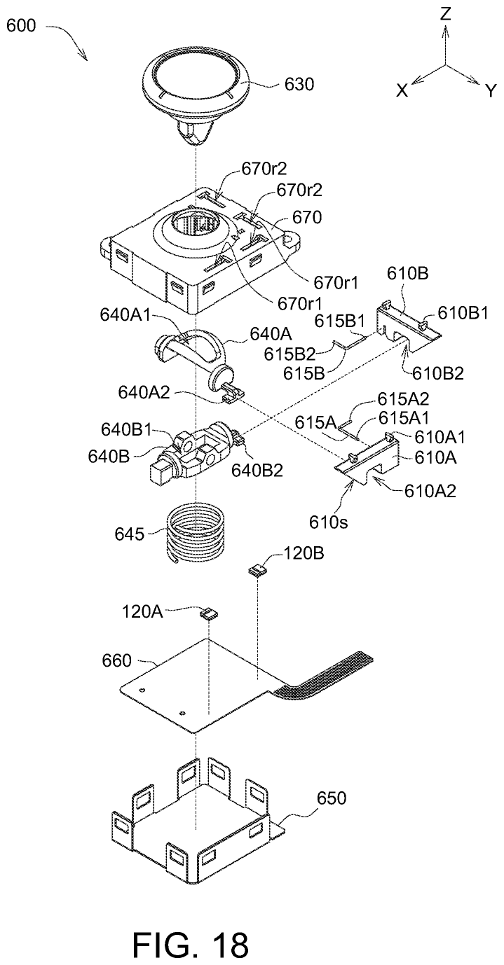

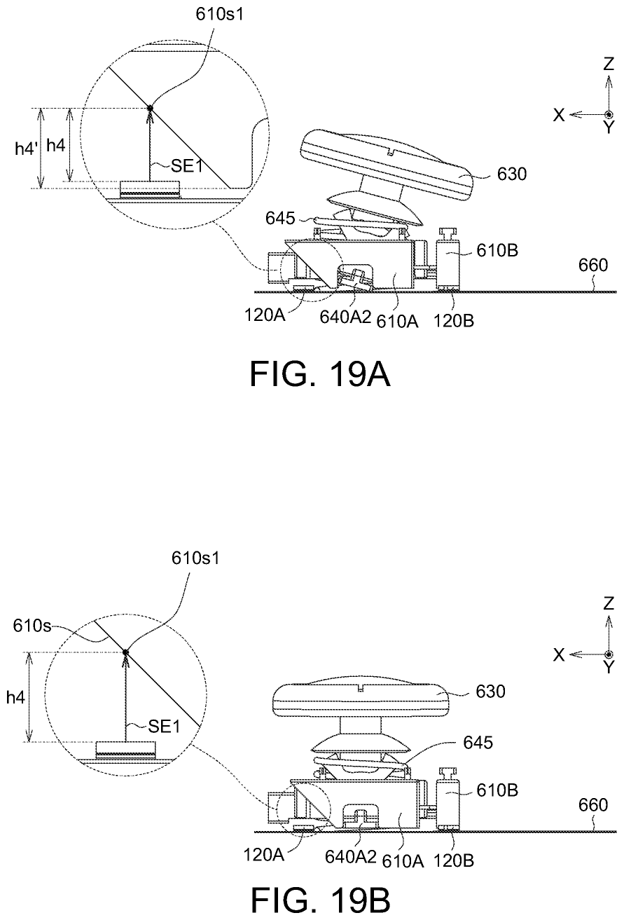

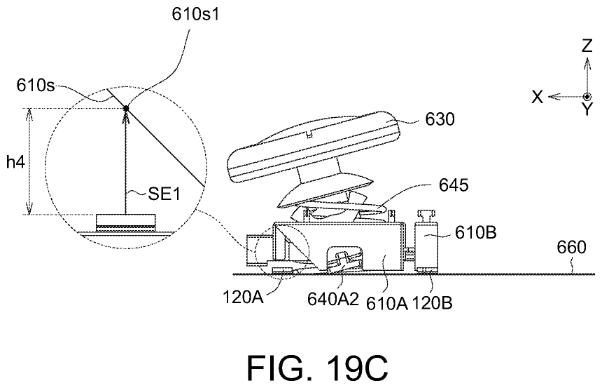

Referring to FIGS. 16 to 18C, FIG. 16 shows a schematic diagram of a joystick module 600 according to another embodiment of the present invention, FIG. 17 shows an internal schematic diagram (the base 650 and the casing 670 not shown) of the joystick module 600 in FIG. 16, FIG. 18 shows a schematic diagram of an exploded view of the joystick module 600 in FIG. 16, and FIGS. 19A to 19C show schematic views of the first movable component 610A of the joystick module 600 in FIG. 16 in a plurality of different positions.

As shown in FIGS. 16 to 17, the joystick module 600 includes at least one movable component (for example, a first movable component 610A and a second movable component 610B), at least one elastic component (for example, a first elastic component 615A and a second elastic component 615B), at least one sensor (for example, the first sensor 120A and second sensor 120B), a joystick 630, at least one swing arm (for example, a first swing arm 640A and a second swing arm 640B), a joystick elastic component 645, a base 650, a circuit board 660 and a casing 670.

As shown in FIGS. 16 to 17, the first sensor 120A and the first movable component 610A form a first sensing group, the second sensor 120B and the second movable component 610B form a second sensing group, and two sensing group have the same or similar technical features (structure, relative arrangement, signal sensing, etc.). The first sensor 120A and the first movable component 610A are taken as examples for illustration below.

As shown in FIGS. 16 to 17, the first sensor 120A is disposed opposite to the first movable component 610A, and is configured for sensing a plurality of the received signals SR from the first movable component 610A. As a result, by determining the differences among these received signals SR, the position information of the movable component or a component (for example, the joystick 130) connected to the movable component could be obtained.

As shown in FIGS. 16 to 18, In the present embodiment, the first movable component 610A and the casing 670 could move relative to each other in a translational direction (for example, the Y-axis). For example, the first movable component 610A includes at least one first sliding block 610A1, the casing 670 has at least one first sliding slot 670r1, and the first sliding block 610A1 is pivotally connected to the first sliding slot 670r1, so that the first movable component 610A and the casing 670 could be relatively moved. The first sliding slot 670r1 extends in the Y-axis, so that the first movable component 610A and the casing 670 could move relative to each other in the Y-axis. The second movable component 6106 and the casing 670 could move relatively in a translational direction (for example, the X-axis). For example, the second movable component 610B includes at least one second sliding block 610131, and the casing 670 has at least one second sliding slot 670r2, and the second sliding block 610B1 is pivotally connected to the second sliding slot 670r2, so that the second movable component 6106 and the casing 670 could relatively move. The second sliding slot 670r2 extends in the X-axis, so that the second movable component 6106 and the casing 670 could move relative to each other in the X-axis.

As shown in FIGS. 16 to 18, the first movable component 610A is, for example, a reflective component. For example, the first movable component 610A has a reflective surface 610s facing the first sensor 120A. The first sensor 120A outputs the emission signal SE1 to the reflective surface 610s. The emission signals SE1 becomes the aforementioned received signal SR after being reflected from the reflective surface 610s.

The reflective surface 610s of the first movable component 610A is, for example, a plane, such as an inclined plane, and a non-zero angle is included between the reflective surface 610s and the XY plane. There is a distance h4′ between the reflective surface 610s and a reference E2 (for example, parallel to the XY plane) of the first movable component 610A, and the distance h4′ gradually increases in the +X-axis. The reference E2 could be a portion of the first movable component 610A, for example, a bottom surface of the first movable component 610A. In another embodiment, the reflective surface 610s could be a curved surface. However, as long as the received signal SR could vary with the movement of the first movable component 610A, the embodiment of the present invention does not limit the geometric form of the reflective surface 610s. In addition, the reflective surface 610s is, for example, a rough surface. The rough surface could diffract the emission signal SE1 and increase the amount of signal received by the first sensor 120A. In an embodiment, the reflective surface 610s has a roughness that is the same as or closes to that of the aforementioned reflective surface 110s. The manufacturing process and/or structure of the reflective surface 610s are similar to the aforementioned reflective surface 110s, and it will not be repeated here.

As shown in FIGS. 9 to 10, the translational direction of the first movable component 610A (for example, parallel to the Y-axis) is substantially perpendicular to the signal emission direction of the first sensor 120A (for example, parallel to the Z-axis). As a result, as the first movable component 610A translates in the Y-axis, the distance between the reflective surface 610s and the first sensor 120A changes, and accordingly the received signal SR reflected from the reflective surface 311s changes.

For example, as shown in FIGS. 19A to 19C, there is a distance h4 between the reflective portion 610s1 of the reflective surface 610s of the first movable component 610A and the first sensor 120A, and the distance h4 could vary with the movement (for example, the position in the Y-axis) of the first movable component 610A, so that the received signal SR reflected from the reflective portion 610s1 also changes accordingly. In the present embodiment, the received signal SR is inversely proportional to the distance h4. In addition, the optical axis LX of the emission signal SE1 emitted by the first sensor 120A could coincide with (or overlap) the reflective surface 610s.

In the present embodiment, the first swing arm 640A, the first movable component 610A, and it could provide a degree of freedom to swing around an axial direction, and accordingly detect the swing angle of the joystick, while the second swing arm 640B, the second movable component 610B and the second sensor 120B could form a second swing sensing mechanism, and it could provide a degree of freedom to swing around another axis, and accordingly detect the corresponding swing angle of the joystick.

As shown in FIGS. 16 to 18, the joystick is connected to the swing arm to drive the swing arm to swing. For example, the joystick 630 could be connected to the first swing arm 640A and the second swing arm 640B, and drives the first swing arm 640A and the second swing arm 640B to swing. The first swing arm 640A has a first slot 640A1 extending in the Y-axis, and the second swing arm 640B has a second slot 640B1 extending in the X-axis. The joystick 130 could pass through the first slot 640A1 of the first swing arm 640A and the second slot 640B1 of the second swing arm 640B. As the joystick 630 moves in the Y-axis, the second swing arm 640B could be driven to swing around the X-axis. As the joystick 630 moves in the X-axis, the first swing arm 640A could be driven to swing around the Y-axis.

As shown in FIGS. 16 to 18, the swing arm is connected to the movable component to drive the movable component to translate. For example, the first swing arm 640A is connected to the first movable component 610A, for example, connected to a position-limited hole 610A2 of the first movable component 610A. For example, the first swing arm 640A includes a first connecting end 640A2 fixed (for example, tightly fitted) to the position-limited hole 610A2 of the first movable component 610A. As the first swing arm 640A swings around the Y-axis, the first connecting end 640A2 of the first movable component 610A rotates synchronously around the Y-axis, and drives the first movable component 610A to translate in the X-axis. In addition, under the proper design to the size of the position-limited hole 610A2 and the size of the first connecting end 640A2, the swing angle of the first swing arm 640A and the distance h4 are in linear relationship, thereby making the swing angle of the joystick 630 around the Y-axis and the received signals SR be in the linear relationship. Similarly, the second swing arm 640B is connected to the aforementioned second movable component 6106, for example, connected to a second position-limited hole 610B2 of the second movable component 6106. For example, the second swing arm 640B includes a second connecting end 640B2 fixed to (for example, tightly fitted) to the second position-limited hole 610B2 of the second movable component 610B. As the second swing arm 640B swings around the X-axis, the second connecting end 640B2 of the second movable component 610B rotates around the X-axis synchronously, and drives the second movable component 610B to translate in the Y-axis. In addition, under the proper design to the size of the position-limited hole 610B2 and the size of the second connecting end 640B2, the swing angle of the second swing arm 640B around the X-axis and the distance h4 are in linear relationship, thereby making the swing angle of the joystick 630 around the X-axis and the received signals SR be in the linear relationship.

As shown in FIGS. 16 to 18, the elastic component (for example, the first elastic component 615A and the second elastic component 615B) is connected to the movable component (for example, the first movable component 610A and the second movable component 610B) for providing the movable component with an elastic recovery force. For example, the first elastic component 615A is connected to the first movable component 610A and the casing 670. The first elastic component 615A includes a first end 615A1 and a second end 615A2, wherein the first end 615A1 is connected to the first movable component 610A, and the second end 615A2 is connected to the casing 670, but could also be connected to the base 650. When the first movable component 610A moves, the first elastic component 615A deforms and stores an elastic potential energy. When the first movable component 610A is released, the first elastic component 615A releases the elastic potential energy to drive the first movable component 610 to restore (or reset). The second elastic component 615B connects the second movable component 610B with the casing 670. The second elastic component 615B includes a third end 615B1 and a fourth end 615B2, wherein the third end 615B1 is connected to the second movable component 610B, and the fourth end 615B2 is connected to the casing 670 or the base 650. When the second movable component 610B moves, the second elastic component 615B deforms to store an elastic potential energy. When the second movable component 6106 is released, the second elastic component 6156 releases the elastic potential energy to drive the second movable component 610B to restore (or reset).

As shown in FIGS. 16 to 18, the joystick elastic component 645 is connected to the joystick 630 for providing an elastic recovery force of the joystick 630. For example, the joystick elastic component 645 connects the joystick 630 with the circuit board 660 or the base 650. When the joystick 630 is pressed, the joystick elastic component 645 deforms to store an elastic potential energy. When the joystick 630 is released, the joystick elastic component 645 releases the elastic potential energy to drive the joystick 630 to restore.

An embodiment of the present invention provides a joystick module which could be applied to an electronic device. In an embodiment, the joystick module includes at least one movable component, at least one signal emitting (or emission) unit and a signal receiving unit. The signal emitting unit could output an emission signal (for example, emitting-light) to the movable component (for example, reflective component), and the emission signal becomes a received signal (for example, reflecting light) after being reflected from the movable component. The received signal could change with the rotation, swing or translation of the movable component, so that the position information (such as a displacement, a displacement velocity, a displacement acceleration, an angle, an angular velocity and/or an angular acceleration) of the movable component and/or its connected components could be obtained. In another embodiment, the joystick module includes at least one movable component (for example, a signal generator) and at least one signal sensor, wherein the movable component (for example, a magnet) could generate a emission signal (for example, a magnetic field), the signal sensor could detect the change of the emission signal, and the position information (such as a displacement, a displacement velocity, a displacement acceleration, an angle, an angular velocity and/or an angular acceleration) of the movable component and/or its connected components could be obtained.

While the invention has been described by way of example and in terms of the preferred embodiment (s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A joystick module, comprising:
a casing;
a movable component disposed inside or outside the casing;
a circuit board;
a base disposed within the casing;
a swing arm disposed within the casing, pivotally connected to the base and connected to the movable component for driving the movable component to move;
a joystick connected to the swing arm for driving the swing arm to move;
a sensor disposed on the circuit board and opposite to the movable component, and configured to sense a plurality of received signals from the movable component;
wherein the received signals are different with the movement of the movable component.

2. The joystick module according to claim 1, wherein the movable component has a reflective surface facing the sensor, and the sensor is an optical sensor.

3. The joystick module according to claim 2, wherein the reflective surface is a curved surface or a plane.

4. The joystick module according to claim 2, wherein the reflective surface is a rough surface.

5. The joystick module according to claim 2, wherein the swing arm is configured to drive the movable component to rotate.

6. The joystick module according to claim 2, wherein the movable component comprises:
a rack having the reflective surface; and
a gear engaged with the rack and configured to drive the rack to translate in a translational direction;
wherein the swing arm is connected with the gear for driving the gear to rotate.

7. The joystick module according to claim 6, wherein the translational direction is substantially parallel to a signal emission direction of the sensor.

8. The joystick module according to claim 6, wherein the translational direction is substantially perpendicular to a signal emission direction of the sensor.

9. The joystick module according to claim 2, wherein the swing arm is configured to drive the movable component to translate.

10. The joystick module according to claim 2, wherein the swing arm is directly connected to the movable component for driving the movable component to rotate.

11. The joystick module according to claim 10, wherein the swing arm comprises:
a connecting end directly connected with the movable component, wherein the connecting end and the movable component are coaxially disposed.

12. A joystick module, comprising:
a casing;
a reflective component disposed inside or outside the casing;
a circuit board;
a base disposed within the casing;
a swing arm disposed within the casing, pivotally connected to the base and connected to the reflective component for driving the reflective component to move;
a joystick connected to the swing arm for driving the swing arm to move;
a light-emitting unit disposed on the circuit board, disposed opposite to the reflective component and configured to output an emission signal to the reflective component; and
a light-receiving unit disposed on the circuit board, disposed opposite to the reflective component and configured to receive a reflected signal of the transmitted signal which is reflected from the reflective component.

13. The joystick module according to claim 12, wherein the reflective component has a reflective surface facing the light-emitting unit and the light-receiving unit.

14. The joystick module according to claim 13, wherein the reflective surface is a curved surface or a plane.

15. The joystick module according to claim 12, wherein the swing arm is configured to drive the reflective component to rotate.

16. The joystick module according to claim 12, wherein the reflective component comprises:
a rack having the reflective surface; and
a gear engaged with the rack and configured for driving the rack to translate in a translational direction;
wherein the swing arm is connected with the gear for driving the gear to rotate.

17. The joystick module according to claim 16, wherein the translational direction is substantially parallel to a signal emission direction of the sensor.

18. The joystick module according to claim 16, wherein the translational direction is substantially perpendicular to a signal emission direction of the sensor.

19. The joystick module according to claim 12, wherein the swing arm is configured to drive the reflective component to translate.

20. A joystick module, comprising:
a casing;
a signal generator disposed outside the casing and configured to generate an emission signal;
a base;
a circuit board disposed on the base;
a signal sensor disposed on the circuit board, disposed opposite to the signal generator and configured to sense the emission signal;
a swing arm disposed within the casing and directly connected to the signal generator; and
a joystick connected to the swing arm for driving the swing arm to move.

21. The joystick module according to claim 20, wherein the swing arm comprises:
a connecting end directly connected with the signal generator, wherein the connecting end and the signal generator are coaxially disposed.
